(19) United States
(12) Patent Application Publication
(10) Pub. No.: US 2010/0073264 A1
(43) Pub. Date: Mar. 25, 2010

(54) DISPLAY MEDIUM INITIALIZATION DEVICE AND RECORDING DEVICE

(75) Inventors: Masahiro SATO, Ebina-shi (JP); Kyotaro TOMODA, Ebina-shi (JP); Shigehiko SASAKI, Ebina-shi (JP); Tsutomu ISHII, Ebina-shi (JP); Yasunori SAITO, Ashigarakami-gun (JP); Hiroe OKUYAMA, Ebina-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/389,918

(22) Filed: Feb. 20, 2009

(30) Foreign Application Priority Data
Sep. 24, 2008 (JP) 2008-244711

(51) Int. Cl. G09G 3/20; G02F 1/01

(52) U.S. Cl. 345/55; 359/242

(57) ABSTRACT

A display medium initialization device includes: a case containing an irradiation unit that irradiates light to an optical-recording-type display medium configured to display an image according to irradiated light; a light-taking unit that takes outside light into the case from outside the case; and a light-guiding unit that guides the outside light taken by the light-taking unit to the irradiation unit.

### CROSS-REFERENCE TO RELATED APPLICATIONS

This application is based on and claims priority under 35 USC 119 from Japanese Patent Application No. 2008-244711 filed on Sep. 24, 2008.

### BACKGROUND

1. Technical Field

The present invention relates to a display medium initialization device and a recording device.

2. Related Art

Techniques for recording an image in an optical-recording-type display medium by irradiating light to the display medium are already known in the relevant technical field.

### SUMMARY

An aspect of the present invention provides a display medium initialization device including: a case containing an irradiation unit that irradiates light to an optical-recording-type display medium configured to display an image according to irradiated light; a light-taking unit that takes outside light into the case from outside the case; and a light-guiding unit that guides the outside light taken by the light-taking unit to the irradiation unit.

### BRIEF DESCRIPTION OF THE DRAWINGS

Exemplary embodiments of the present invention will be described in detail below with reference to the following figures, wherein:

FIG. 1 is a block diagram illustrating a configuration of a recording device according to an exemplary embodiment;

FIG. 2 is a diagram illustrating a configuration of a recording unit according to an exemplary embodiment;

FIG. 3 is a diagram illustrating a configuration of an electronic paper according to an exemplary embodiment;

FIG. 4 is a diagram illustrating a configuration of a recording unit according to a first modification;

FIG. 5 is a diagram illustrating a configuration of a recording unit according to a second modification;

FIG. 6 is a diagram illustrating a configuration of a recording unit according to a third modification;

FIG. 7 is a diagram illustrating a configuration of a recording unit according to a fourth modification; and

FIG. 8 is a diagram illustrating a property of an electronic paper according to a seventh modification.

### DETAILED DESCRIPTION

An exemplary embodiment of the present invention will be described.

FIG. 1 is a block diagram illustrating a configuration of recording device 1 according to an exemplary embodiment. Recording device 1 shown in the drawing is a device for recording an image in electronic paper 200 or deleting an image from electronic paper 200 (initialization), which is an optical-recording-type display medium, and which includes recording unit 100, controller 110, and data obtaining unit 150. Recording unit 100 includes reset light generator 120, recording light generator 130, and voltage applying unit 140.

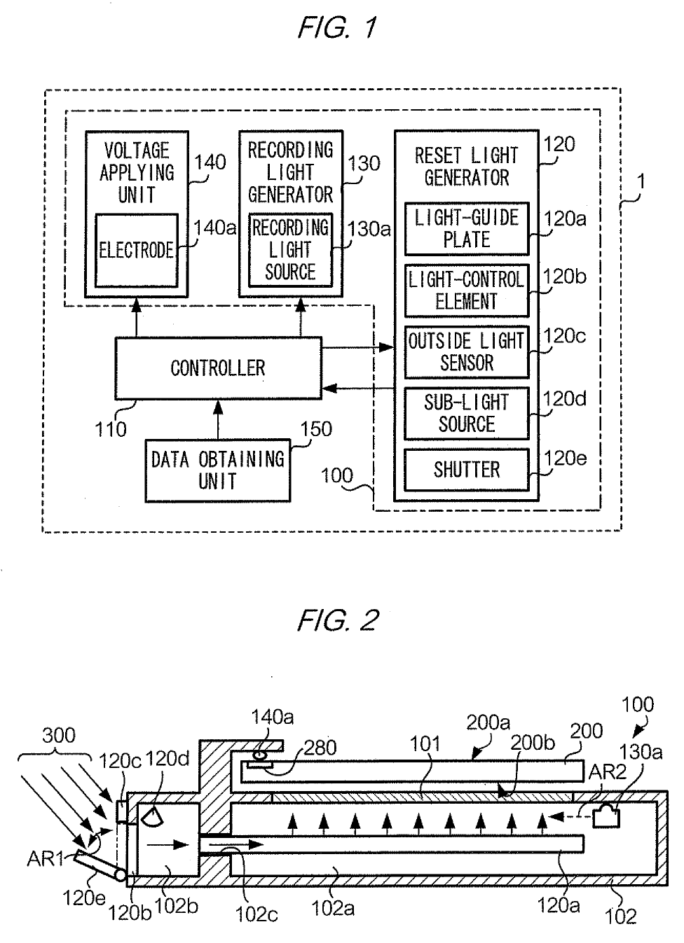

FIG. 2 is a diagram illustrating a configuration of recording unit 100. Recording unit 100 holds or houses electronic paper 200 in a given manner so that light generated by reset light generator 120 or recording light generator 130 is irradiated to electronic paper 200. Hereinafter, each component of recording device 1 will be described with reference to FIGS. 1 and 2.

Controller 110 includes a processor such as a CPU (Central Processing Unit), which controls the operation of recording device 1. For example, controller 110 provides a control signal to reset light generator 120, recording light generator 130, and voltage applying unit 140 on the basis of data obtained by data obtaining unit 150 and data output from outside light sensor 120c of reset light generator 120, to control the components.

Data obtaining unit 150 obtains image data representing an image to be recorded in electronic paper 200. Data obtaining unit 150 may obtain image data from a storage unit such as an internal memory provided in recording device 1 or from outside recording device 1, for example, via a recording medium such as a non-volatile memory or wired/wireless communication. Data obtaining unit 150 may obtain an instruction from a user, input via an operation unit, whereby recording of an image starts.

Now, each component of recording unit 100 will be described. Case 102 is made of light-shielding material, and houses reset light generator 120, recording light generator 130, and voltage applying unit 140. Case 102 holds electronic paper 200 to which an image is recorded or which is initialized. Case 102 contains space 102a and transparent plate 101 described later. Case 102 also contains space 102b and light control element 120b described later. Space 102a and space 102b are connected via a slit-like opening 102c into which light-guide plate described later is inserted.

Inside case 102, if electronic paper 200 is held by case 102, and shutter 120e is closed, as described later, outside light 300 does not enter. Light shielding material forming case 102 may have a low light transmission sufficient to block outside light 300. Outside light 300 may be light generated outside case 102 such as sunlight or fluorescent light.

Transparent plate 101 is made of a translucent material, which defines a radiation area within which light generated inside case 102 is radiated to recording surface 200b of electronic paper 200 held by case 102. Since transparent plate 101 defines a radiation area, translucent material making up translucent plate 101 may be material that has a high light transmission and has less optical distortion. When electronic paper 200 is held by case 102, translucent plate 101 is covered by the electronic paper so that light is prevented from entering into case 102.

Reset light generator 120 includes light-guide plate 120a, light-control element 120b, outside light sensor 120c, sub-light source 120d, and shutter 120e. Reset light generator 120 generates light (reset light) for deleting an image recorded in electronic paper 200 before a new image is recorded in the electronic paper.

Light-guide plate 120a has a planar shape, and is made of material having an optical property such that if light enters one end face of the material, the light is irradiated from a surface of the material. Light-guide plate 120a is provided in space 102a so that the plate irradiates light in a direction toward transparent plate 101. Light-guide plate 120a is also provided so that the plate runs through opening 102c and one end face of the plate that light enters faces space 102b. Accordingly, light entering space 102b is irradiated in space 102a via light guide plate 120a. A path of light other than light guide plate 120a is cut by case 102. Light entering space 102b is outside light 300 or light irradiated from sub-light source 120d, as described later. Light-guide plate 120a guides outside light 300 or light irradiated from sub-light source 120d to a radiation area.

Shutter 120e is a light-shielding member provided outside case 102, which opens or closes under control of controller 110, as indicated by arrow AR1 shown in FIG. 2. A position of shutter 120 which is opened so that outside light 300 enters space 102b is shown by a solid line, and a position of shutter 120 which is closed so that outside light 300 does not enter space 102b is shown by a two-dot chain line.

Outside light sensor 120c is provided outside case 102, and measures intensity of outside light 300 to output a signal indicating the measured intensity to controller 110. Outside sensor 120c is an element that converts light into electrical signals such as a photodiode, a phototransistor, or a cadmium cell. It is to be noted that outside sensor 120c may be provided inside case 102, if the sensor provided in the position is able to directly or indirectly measure intensity of outside light 300.

Light-control element 120b is an element that changes its light transmission under control of controller 110, which may be a liquid crystal shutter or an electrochromic element that changes its light transmission according to an electrical signal, or a thermochromic element that changes its light transmission according to temperature. Light-control element 120b is arranged in a position through which outside light 300 passes when shutter 120e is caused to open and outside light 300 is allowed to enter space 102b, and attenuates intensity of outside light 300 so that outside light 300 guided to a radiation area is reduced. Light-control element 120b may be a photochromic element that changes its light transmission according to the intensity of incident light so that light passing through the element is attenuated to a predetermined intensity. In the case where a photochromic element is used, controlling by controller 110 is not necessary.

Sub-light source 120d is provided in space 102b, and emits light at an intensity controlled by controller 110. Sub-light source 120d may be an element that converts electricity into light such as a LED (Light Emitting Diode), a cold-cathode tube, or an EL (Electro-Luminescent) device.

Recording light generator 130 has recording light source 130a, which generates light (recording light) for recording an image in electronic paper 200. Recording light source 130a may be a LED array including plural LEDs arranged in a linear order and a lens of each of which focuses light generated by a corresponding LED within a range according to a resolution at which an image is recorded. Blinking of each LED is controlled by controller 110. Recording light source 130a is controlled by controller 110 to move in the direction of AR2 shown in FIG. 2. Recording light source 130a emits light to recording surface 200b of electronic paper 200 within a radiation area, which is traversed on the surface. Light emitted and traversed by recording light source 130a may be, instead of linear arrayed light, a spotlight generated using a semiconductor laser. Alternatively, light may be emitted by a surface-emitting light source.

Voltage applying unit 140 includes electrode 140a, which applies a voltage to electrode 140a under control of controller 110. When electronic paper 200 is held by recording unit 100, electrode 140a electrically contacts with electrode 280 (described later) of electronic paper 200 so that a voltage controlled by controller 110 is applied between transparent electrodes 220 and 260 of electronic paper 220.

The foregoing is a description of a configuration of recording device 1.

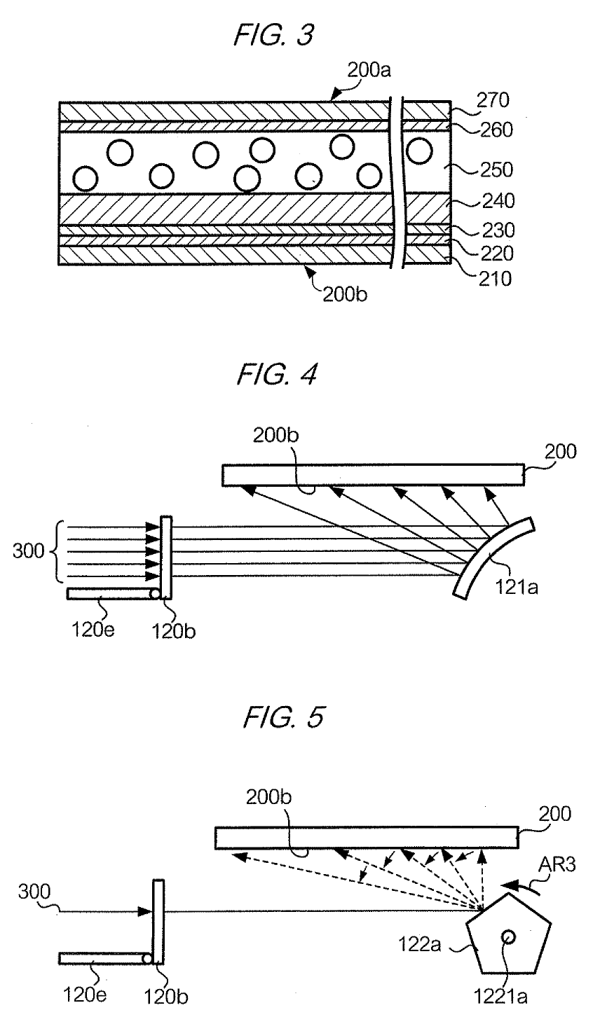

Now, a configuration of electronic paper 200 that is an optical-recording-type display medium will be described. FIG. 3 is a diagram illustrating a configuration of electronic paper 200. Electronic paper 200 includes, in a recording area for recording an image, film substrates 210 and 270, transparent electrodes 220 and 260, photoconductive layer 230, colored layer 240, and display element layer 250, and, outside the recording area, electrodes 280 each of which is connected to one of transparent electrodes 220 and 260.

Film substrates 210 and 270 are layers for protecting the surface of electronic paper 200, which may be made of PET (Polyethylene Terephthalate). Film substrate 210 has recording surface 200b to which reset light or recording light is irradiated. Film substrate 270 has display surface 200a on which a recorded image is viewed by a user. Transparent electrodes 220 and 260 each comprise a layer made of ITO (Indium Tin Oxide). Electrodes 280 connected to transparent electrodes 220 and 260 are connected with electrode 140a of recording device 1, as described above, and if a voltage is applied to electrode 140a under control of controller 110, a difference in potential is caused between transparent electrodes 220 and 260.

Photoconductive layer 230 is a layer made of a conductive material in which a conductivity changes according to an intensity of light irradiated. Photoconductive layer 230 may be an organic photo conductor. Colored layer 240 is a layer that can be viewed when display element layer 250 is transparent to light, and which is in a given color (e.g., black).

Display element layer 250 is a layer including a display element whose reflectivity of light changes according to an applied voltage. In display element layer 250, microencapsulated cholesteric liquid crystal display elements are dispersed in binder resin. A cholesteric liquid crystal display element has two types of orientational state: a planar orientational state, and a focal conic orientational state, and has a memory property of maintaining a state even while no voltage is applied. In a planar orientational state, a cholesteric liquid crystal display element reflects light (Bragg reflection), thus taking on a given color; whereas, in a focal conic orientational state, a cholesteric liquid crystal display element is transparent to light, as a result of which the color of colored layer 24 is visible.

To cause electronic paper 200 to record and display an image, a recording light is irradiated to recording surface 200b of electronic paper 200 while a given recording voltage is applied between transparent electrodes 220 and 260, and the application of the recording voltage is suspended. The irradiation of recording light to recording surface 200b changes conductivity of photoconductive layer 230, as described above. As a result, a voltage applied to display element layer 250 changes, whereby reflectivity of light of display elements changes; and accordingly, reflectivity of display surface 200a changes.

To delete an image recorded in electronic paper 200 and initialize the electronic paper, reset light is irradiated to recording surface 200b while a given reset voltage is applied between transparent electrodes 220 and 260, and thereafter the application of the reset voltage is suspended. An initialization of electronic paper 200 is performed before an image is recorded in the electronic paper. Reset light may be more intense than recording light. If a total amount of energy of reset light irradiated per unit area reaches a predetermined value, reflectivity of recording surface 200b recovers.

The foregoing is a description of a configuration of electronic paper 200.

Now, man operation of recording device 1 will be described. In the following description, it is assumed that electronic paper 200 is held by case 102 of recording device 1 so that recording surface 200b of electronic paper 200 faces transparent plate 101 of recording unit 100, and electrodes 280 and electrode 140a are connected with each other, and that recording device 1 is ready for initialization and recording of an image.

If data obtaining unit 150 obtains image data representing an image to be recorded in electronic paper 200, and further receives an instruction to record the image in electronic paper 200, electronic paper 200 is initialized, and thereafter an operation of recording the image in electronic paper 200 is started.

In the initialization process, controller 110 measures intensity of outside light 300 on the basis of a signal output from outside-light sensor 120c. Controller 110 also causes voltage-applying unit 140 to apply a reset voltage to electronic paper 200 via electrode 140a. Subsequently, while a reset voltage is applied to electronic paper 200, controller 110 causes shutter 120e to open for a predetermined time period.

Controller 110 also controls light-control element 120b and sub-light source 120d on the basis of the measured intensity of outside light 300. Specifically, controller 110 controls the light transmission of light-control element 120b and the intensity of emission of sub-light source 120d so that intensity of light guided to a radiation area is equal to intensity predetermined to be that of reset light. To carry out the control, controller 110 stores a table that defines a relation between intensity of outside light 300 and light transmission of light-control element 120b and a relation between intensity of outside light 300 and intensity of emission of sub-light source 120d. The relation of the former is defined so that the higher intensity of outside light 300, the lower light transmission of light-control element 120b, and the relation of the latter is defined so that the lower the intensity of outside light 300 is, the higher the intensity of emission of sub-light source 120d becomes. A range of intensity of outside light 300, in which light transmission of light-control element 120b is controlled, and a range of intensity of outside light 300, in which intensity of emission of sub-light source 120d is controlled, may overlap each other.

Controller 110, if the measured intensity of outside light 300 is high so that intensity of light guided to a radiation area exceeds intensity predetermined to be that of reset light, causes sub-light source 120d not to emit light, and causes light-control element 120b to lower its light transmission, to attenuate the intensity of outside light 300, thereby to reduce light guided to a radiation area. On the other hand, if the measured intensity of outside light 300 is low so that intensity of light guided to a radiation area does not exceed intensity predetermined as that of reset light, controller 110 causes sub-light source 120d to emit light, and causes light-control element 120b to maximize its light transmission so that outside light 300 and light emitted from sub-light source 120d are guided to a radiation area.

A time period for which sub-light source 120d is caused to emit light may be the same as a time period for which shutter 120e is caused to open, or the two time periods may differ. In essence, it is only necessary that while a reset voltage is applied to electronic paper 200, light is guided to a radiation area for a predetermined time period, and that a total amount of energy of the guided light per unit area amounts to a predetermined value. For example, controller 110 may, without controlling emission intensity of sub-light source 120d, control a light emission time of sub-light source 120d so that the lower the emission intensity is, the longer a light emission time becomes, and the higher the emission intensity is, the shorter a light emission time becomes.

Alternatively, if intensity of outside light 300 is lower than a predetermined value, controller 110 may leave shutter 120e closed and cause sub-light source 120d to emit light.

According to the control of controller 110 described above, outside light 300 and light emitted from sub-light source 120d enter one end face of light guide plate 120a that faces space 102b, and are guided to a radiation area as reset light. Controller 110 causes shutter 120e to close, causes voltage-applying unit 140 to stop application of a reset voltage, and ends an initialization operation. In the initialization operation, since outside light 300 is used as light irradiated to electronic paper 200, electricity for irradiating light to electronic paper 200 is smaller than in a case in which outside light 300 is not used.

After the initialization process is completed, a recording process is started. In the recording process, controller 110 causes voltage-applying unit 140 to generate and apply a recording voltage to electronic paper 200 via electrode 140a. Subsequently, controller 110 causes recording light generator 130 to emit recording light according to image data to recording surface 200b of electronic paper 200. After recording light is emitted, controller 110 causes voltage-applying unit 140 to stop the application of a recording voltage. With this step, the operation of recording an image in electronic paper 200 ends. The foregoing is a description of an operation of recording device 1.

The exemplary embodiment of the present invention described above may be modified as described below.

### <First Modification>

In the above exemplary embodiment, where light guide plate 120a is used as a member for guiding outside light 300 to a radiation area, convex mirror 121a may be used instead, as shown in FIG. 4. In a case that convex mirror 121a is used, the curved surface shape of the mirror surface of convex mirror 121a is optically designed so that outside light 300 is guided to the whole radiation area. According to thus configured convex mirror 121a, outside light 300 coming from outside case 102 and passing through opening 102c is reflected to a radiation area.

### <Second Modification>

In the above exemplary embodiment, where light-guide plate 120a is used as a member for guiding outside light 300 to a radiation area, rotating mirror 122a such as a polygon mirror may be used, as shown in FIG. 5. Rotating mirror 122a is caused to rotate around axis of rotation 1221a in the direction of arrow AR3 shown in FIG. 5, by controller 110. Outside light 300 taken into space 102b of case 102 and passing through opening 102c is reflected by rotating mirror 122a to a radiation area. Since rotating mirror 122a is rotatable, outside light 300 can be reflected to the whole radiation area.

Controller 110 may set the rotational rate of rotating mirror 122a so that a total amount of energy of light irradiated to a radiation area per unit area amounts to a predetermined value. This is based on an assumption that intensity of light taken into space 102b is constant. However, if intensity of light taken into space 102b is not constant; for example, if the light transmission of light control element 120b is not controlled by controller 110, controller 110 may change a rotational rate of rotating mirror 122a according to measured intensity of outside light 300 so that a total amount of energy of light irradiated to a radiation area per unit area amounts to a predetermined value.

### <Third Modification>

In the above exemplary embodiment, where light guide plate 120a is used as a member for guiding outside light 300 to a radiation area, movable mirror 123a may be used, as shown in FIG. 6. Movable mirror 123a is caused to move in the direction of arrow AR4 shown in FIG. 6, by controller 110. Outside light 300 taken from outside case 102 and passing through opening 102c is reflected by movable mirror 123a to a radiation area. Since movable mirror 123a is movable, outside light 300 can be reflected to the whole radiation area.

Controller 110 may set the movement rate of movable mirror 123a so that a total amount of energy of light irradiated to a radiation area per unit area amounts to a predetermined value. This is based on an assumption that intensity of light taken into space 102b is constant. However, if intensity of light taken into space 102b is not constant; for example, if the light transmission of light control element 120b is not controlled by controller 110, controller 110 may change a movement rate of movable mirror 123a according to measured intensity of outside light 300 so that a total amount of energy of light irradiated to a radiation area per unit area amounts to a predetermined value.

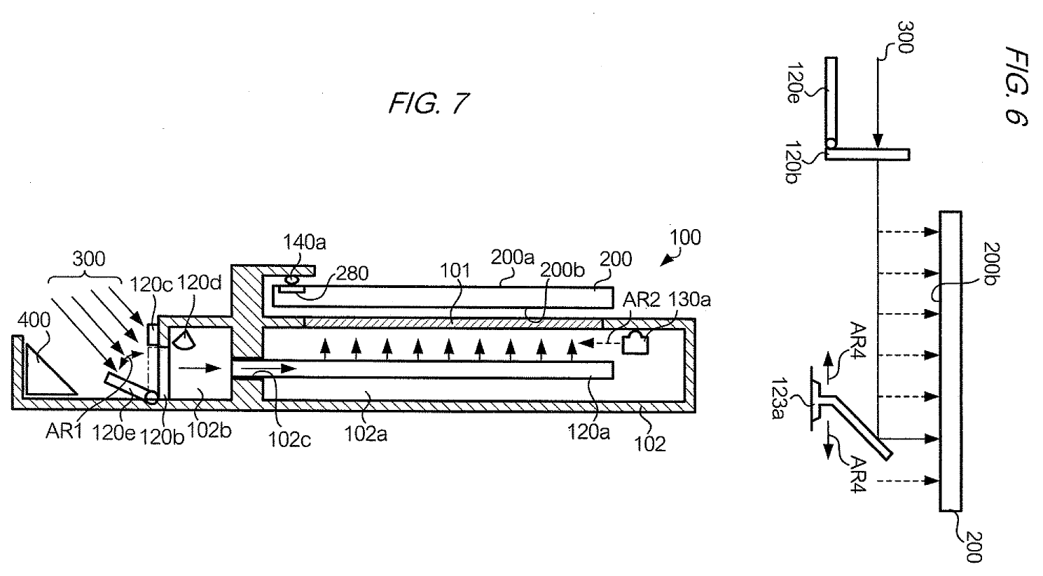

In the above exemplary embodiment, light-storing member 400 may be used, as shown in FIG. 7. Light-storing member 400 is made of material having a property of absorbing and storing sunlight or panel light, and if the amount of light in the surroundings is small, emitting light. If light-storing member 400 is used, outside light 300 and light stored in light-storing member 400 are allowed to enter space 102b.

### <Fifth Modification>

In the above exemplary embodiment, where shutter 120e is caused to open during a predetermined time period by controller 110, the time period may be changed according to measured intensity of outside light 300. Specifically, controller 110 may change the time period so that the higher the intensity of outside light 300 is, the shorter the time period becomes, and the lower the intensity of outside light 300 is, the longer the time period becomes; as a result, a total amount of energy irradiated to a radiation area per unit area amounts to a predetermined value.

Since the higher the intensity of outside light 300 is, the shorter a time period for allowing outside light 300 to enter space 102b becomes, to control the amount of energy of light irradiated to a radiation area per unit area, light-control element 120b may be unnecessary. However, in a case in which intensity of outside light 300 is high enough to deteriorate electronic paper 200 or high enough to make a time period for which shutter 120e is opened too short to control the shutter, light-control element 120b may be used to attenuate intensity of guided light.

### <Sixth Modification>

In the above exemplary embodiment, it is possible not to use shutter 120e. If shutter 120e is not used, in a case in which shutter 120e is caused to close in the above exemplary embodiment, controller 110 may set the light transmission of light control element 120b to a value less than the predetermined value in the exemplary embodiment, and in a case in which shutter 120e is caused to open in the above exemplary embodiment, controller 110 may control light-control element 120b as in the case of the exemplary embodiment.

In the above fifth modification, if shutter 120e is not used, instead of a time period for which shutter 120e is opened, the light transmission of light control element 120b may be changed according to measured intensity of outside light 300.

### <Seventh Modification>

In the above exemplary embodiment, where outside light 300 is used as reset light, outside light 300 may be used for any other purpose. For example, outside light 300 may be used as part of recording light, as described below.

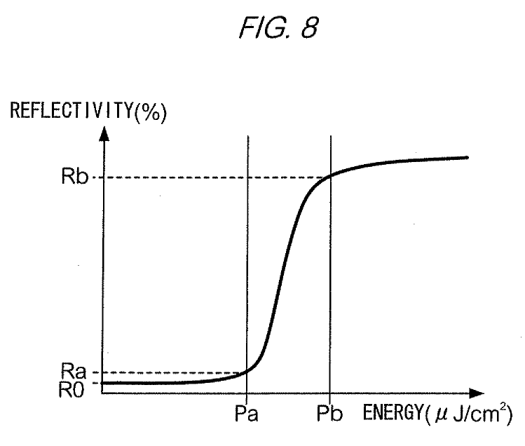

FIG. 8 is a diagram illustrating a relation between a total amount of energy of light irradiated per unit area (hereinafter, simply referred to as “energy”), the light being irradiated to recording surface 200b of electronic paper 200 during a given recording period while a recording voltage is applied to electronic paper 200, and reflectivity. The horizontal axis is a scale of the energy of light irradiated to recording surface 200b, which is expressed as a logarithmic axis, and the vertical axis is a scale of the reflectivity of display surface 200a. As shown in FIG. 8, before light is irradiated, reflectivity is R0, and as energy of irradiated light increases, reflectivity increases. Also, a rate of change of reflectivity with respect to change of energy of irradiated light in a certain energy range is larger than that of other areas of energy.

The certain energy range is an energy range of Pa to Pb shown in FIG. 8, in which reflectivity changes from Ra to Rb. Accordingly, a rate of change of reflectivity is less than or equal to (Ra−R0) until energy of irradiated light reaches Pa; which rate is lower than that of the certain energy range. Energy needed to record an image in electronic paper 200 is equal to or greater than Pa. It is to be noted that if gradation expression is not necessary to record an image, energy of light to be irradiated may be set to be equal to or greater than Pb.

In the present modification, when recording an image in electronic paper 200 having the property described above, recording device 1 uses light generated by recording light source 130a and outside light 300 as light irradiated to recording surface 200b. Specifically, controller 110 may adjust intensity of outside light 300 by controlling the light transmission of light control element 120b, or adjust an irradiation time of outside light 300 by controlling the opening and closing of shutter 120e so that energy of outside light 300 guided to a radiation area amounts to a given value which is less than or equal to Pa, in other words, so that the amount of change of reflectivity is less than or equal to a given value, (Ra−R0). The given value may be, instead of (Ra−R0), another value such as (R0+1 percent).

Controller 110 also controls the intensity of light and moving speed of recording light source 130a so that the total of the energy of outside light 300 irradiated to recording surface 200b of electronic paper 200 during a recording period and the energy of light irradiated from recording light generator 130a corresponds to reflectivity according to image data obtained by data obtaining unit 150, to store an image represented by the image data in electronic paper 200. Since outside light 300 is used as part of recording light for recording an image in electronic paper 200, electricity used by recording light source 130a is reduced.

It is to be noted that it is not necessary to irradiate light generated by recording light source 130a and outside light 300 during an entire recording period. Light generated by recording light source 130a and outside light 300 may be irradiated during only a part of a recording period. Also, it is not necessary to simultaneously irradiate light generated by recording light source 130a and outside light 300. Either light generated by recording light source 130a or outside light 300 may be irradiated in advance. In essence, it is only necessary to have light irradiated to recording surface 200b of electronic paper 200 during a recording period, which corresponds to reflectivity according to image data.

In the above exemplary embodiment, an initialization operation may include, in addition to the operation of deleting an image by irradiating reset light, or an operation of making reflectivity of display surface 200a uniform, as described in the above exemplary embodiment, the operation of irradiating light to recording surface 200b, having energy (in the present modification, energy less than or equal to Pa) sufficient to raise reflectivity significantly, as described in the present modification. Namely, an initialization operation may be an operation of irradiating outside light 300 having predetermined energy to recording surface 200b.

### <Eighth Modification>

In the above exemplary embodiment, recording device 1 is configured to carry out both an initialization operation and a recording operation. However, recording device 1 may be configured as an initialization device for carrying out only an initialization.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display medium initialization device comprising:
a case containing an irradiation unit that irradiates light to an optical-recording-type display medium configured to display an image according to irradiated light;
a light-taking unit that takes outside light into the case from outside the case; and
a light-guiding unit that guides the outside light taken by the light-taking unit to the irradiation unit.

2. The display medium initialization device according to claim 1, further comprising:
a measuring unit that measures intensity of the outside light taken by the light-taking unit; and
a light-reducing unit that reduces the outside light guided by the light-guiding unit to the irradiation unit, according to the intensity of the outside light measured by the measuring unit.

3. The display medium initialization device according to claim 1, further comprising:
a measuring unit that measures intensity of the outside light taken by the light-taking unit; and
a light-emitting unit that emits light at an intensity according to the intensity of the outside light measured by the measuring unit, wherein the light-guiding unit guides the outside light taken by the light-taking unit and the light emitted by the light-emitting unit to the irradiation unit.

4. The display medium initialization device according to claim 1, further comprising:
a measuring unit that measures intensity of the outside light taken by the light-taking unit; and
a controller that controls a time period for which the outside light is taken by the light-taking unit, according to the intensity of the outside light measured by the measuring unit.

5. A display medium initialization device comprising:
a case containing an irradiation means for irradiating light to an optical-recording-type display medium configured to display an image according to irradiated light;
a light-taking means for taking outside light into the case from outside the case; and
a light-guiding means for guiding the outside light taken by the light-taking means to the irradiation means.

6. A recording device comprising:
the display medium initialization device according to claim 1; and
a recording unit that causes the irradiation unit to irradiate light according to data of an image to the display medium, to record the image in the display medium, wherein the light-taking unit does not take the outside light into the case while the recording unit is recording the image in the display medium.
